(19) United States
(12) Patent Application Publication
(10) Pub. No.: US 2026/0210336 A1
(43) Pub. Date: Jul. 23, 2026

(54) WIND TURBINE CONTROL FOR LIMITING ROTOR THRUST

(71) Applicant: VESTAS WIND SYSTEMS A/S, Aarhus N (DK)

(72) Inventors: Mikael Aslak SVENSTRUP, Hinnerup (DK); Christian JEPPESEN, Horsens (DK); Anders Druedahl THURLOW, Silkeborg (DK)

(21) Appl. No.: 19/141,565

(22) PCT Filed: Dec. 21, 2023
(86) PCT No.: PCT/DK2023/050329

§ 371 Date: Jun. 20, 2025

(30) Foreign Application Priority Data
Dec. 22, 2022 (DK) PA202270643

(51) Int. Cl. F03D 17/00; F03D 7/02; F03D 7/04

(52) U.S. Cl. CPC F03D 17/011; F03D 7/0224; F03D 7/042; F03D 17/0285; F05B 2270/331

(57) ABSTRACT

Aspects of the invention relate to a method of controlling a wind turbine comprising a rotor and a plurality of rotor blades. The method comprises: receiving a plurality of blade flap load signals indicative of measured flap loading on respective rotor blades, each blade flap load signal being received from a blade flap load sensor of a respective rotor blade; determining an average blade flap load signal based, at least in part, on the plurality of blade flap load signals; and determining a maximum thrust level for a thrust limit controller based on the average blade flap load signal and a reference load value that is indicative of a maximum allowable variation of the average blade flap load signal from a normal value.

### TECHNICAL FIELD

The present invention relates to a method of controlling a wind turbine. In particular, the invention relates to a method of controlling a wind turbine to limit rotor thrust during variable wind conditions, for example due to gusts. Aspects of the invention relate to a method, to a computer-readable storage medium, to a controller and to a wind turbine.

### BACKGROUND

Wind turbines typically include one or more controllers for controlling various components of the wind turbine. For instance, wind turbine controllers may be used to control a pitch angle of the rotor blades of the wind turbine and/or a speed of a generator of the wind turbine. Wind turbine controllers may control components with the aim of maximising power production/energy captured by the wind turbine from the wind, and/or minimising loads experienced by various wind turbine components during operation.

Wind turbine controllers typically determine control actions or set points for the components based on various operational parameters associated with the operation of the wind turbine. For example, a rotor blade load or current wind speed in the vicinity of a wind turbine may be used by wind turbine controllers to determine appropriate control actions.

An issue exists in that some wind turbine controllers need to react—i.e. to provide suitable control actions—to relatively fast changes in wind speed in order to mitigate loads and stresses experienced by the wind turbine tower. For instance, a controller for limiting thrust loads experienced by the wind turbine rotor needs to react to fast load changes, e.g. due to gusts that produce sudden rises in blade load. However, filters used to remove high frequency noise content from the measured/estimated wind speed or blade load can have the undesired effect of also filtering out these faster (i.e. shorter timescale) changes. This can result in non-optimal performance of controllers during the shorter timescale changes.

It is against this background that the present invention has been devised.

### SUMMARY OF THE INVENTION

According to an aspect of the invention there is provided a method of controlling a wind turbine comprising a rotor and a plurality of rotor blades. The method comprises: receiving a plurality of blade flap load signals indicative of measured flap loading on respective rotor blades, each blade flap load signal being received from a blade flap load sensor of a respective rotor blade; determining an average blade flap load signal based, at least in part, on the plurality of blade flap load signals; and determining a maximum thrust level for a thrust limit controller based on the average blade flap load signal and a reference load value that is indicative of a maximum allowable variation of the average blade flap load signal from a normal value.

In the context of the invention, the normal value is therefore a load value that is expected for the current conditions and the maximum allowable variation represents the extent to which that load is reasonably expected to vary during those conditions. The average blade flap load signal is a signal that vary with the blade load signals and the reference signal determines how much the average blade flap load signal may vary before a maximum thrust level is modified, typically reduced. To give an example, the reference load value may be a multiple, X1, of a standard deviation of the varying average blade flap load signal from a mean value of that signal, where the mean value represents the normal value, i.e. in this example the normal value is set to the mean value of the varying average blade flap load signal, and X1 times the standard deviation represents the maximum allowable variation before a maximum thrust level is modified.

In this manner, the cyclic variation of the flap load at each individual blade is substantially neutralized in the average blade flap load signal, which can therefore be used to detect whether the average blade flap load varies outside of the acceptable range for normal operation (by exceeding the reference load value). The maximum thrust level can then be adjusted accordingly to protect the wind turbine, allowing the wind turbine to respond quickly to relatively sudden load changes, as may be caused by gusts, and mitigate excessive loads.

In an example, the method further comprises determining the reference load value based on respective intervals of the average blade flap load signal. Optionally, the reference load value is determined at a prescribed frequency. The reference load may be determined at each timestep of the sample loads, for example. In this manner, the reference load value is indicative of a maximum allowable variation of the average blade flap load signal from a normal value for a respective period or respective operating conditions.

Optionally, the reference load value is based on a standard deviation of the average blade flap load signal. Optionally, the normal value of the average blade flap load is a mean value of the average blade flap load signal. This provides a convenient measure of acceptable load variations that adapts to the conditions.

In an example, the maximum thrust level is determined as: a first thrust level if the average blade flap load signal is less than or equal to the reference load value; and a second thrust level if the average blade flap load signal is greater than the reference load value, wherein the second thrust level is less than the first thrust level. In this manner, the maximum thrust level is reduced when the average blade flap load signal increases above the reference load value. The first and second thrust levels may be respective values of a maximum allowable thrust force, for example.

Optionally, determining the maximum thrust level further comprises: comparing the average blade flap load signal to a further reference load value that is indicative of a greater variation of the average blade flap load signal from the normal value; and determining the maximum thrust level as the second thrust level if the average blade flap load signal is greater than the further reference load value. In this manner, the maximum thrust level may be held at the second thrust level, while the average blade flap load signal is greater than the further reference level. The second thrust level may therefore be set so as to correspond to a minimum acceptable rate of power production.

In an example, the method further comprises determining the maximum thrust level based on a function for transitioning from the first thrust level to the second thrust level, if the average blade flap load signal is greater than the reference load value but less than or equal to the further reference load value. Optionally, the function includes a proportional reduction from the first thrust level toward the second thrust level according to a difference between the average blade flap load signal and the reference load value. The proportional reduction may allow for a rapid change in the maximum thrust level, ramping down from the first to the second thrust level (or vice versa).

Optionally, the further reference load value is also based on the standard deviation of the average blade flap load signal. For example, the reference load value and the further reference load value may be equal to respective multiples, X1 and X2, of the standard deviation of the average blade flap load signal from the mean of the average blade flap load signal. X2 may be greater than X1. The multiples may be tunable values set in view of the wind turbine design, tunable to set how much the average blade flap load signal may vary before the maximum thrust level is modified.

Optionally, determining at least one of the reference load value, and/or the further reference load value, comprises applying a low-pass filter to the standard deviation of the average blade flap load signal.

Optionally, each of the plurality of blade flap load signals are high pass filtered prior to determining the average blade flap load signal based thereon. In this manner, the average blade flap load signal may be effectively centred about the mean, i.e. the high pass filter may produce an average blade flap load signal having a zero-mean value. In this manner, there is no explicit need to determine the normal value as the mean value, instead the normal value (relative to which the average blade flap load variations are assessed) can be considered to be zero.

Optionally, a notch filter is applied to the average blade flap load signal prior to determining the maximum thrust level based thereon. The notch filter may be configured to remove cyclic variations of each rotor blade passing the wind turbine tower and may therefore have a frequency of approximately three times the rotor frequency.

Optionally, a hold function is applied to the determined maximum thrust level. The hold function may serve to improve stability, for example, by preventing cyclic pitching of the rotor blades. The hold function may be implemented as an asymmetric hold function.

In examples, the method may further comprise outputting the determined maximum thrust level to the thrust limit controller to control a pitch angle of the plurality of rotor blades based on the determined maximum thrust level. In this manner, the rotor blades may be pitched to limit a maximum rotor thrust experienced by the wind turbine.

According to a further aspect of the invention there is provided a computer program comprising instructions which, when the program is executed by a computer, cause the computer to carry out the method of the first aspect.

According to another aspect of the invention there is provided a non-transient, computer-readable storage medium storing instructions thereon that when executed by one or more processors cause the one or more processors to execute a method as described in a previous aspect of the invention.

According to a further aspect of the invention there is provided a control system for a wind turbine comprising a rotor and a plurality of rotor blades. The control system comprises one or more controllers configured to: receive a plurality of blade flap load signals indicative of measured flap loading on respective rotor blades, each blade flap load signal being received from a blade flap load sensor of a respective rotor blade; determine an average blade flap load signal based, at least in part, on the plurality of blade flap load signals; and determine a maximum thrust level for a thrust limit controller based on the average blade flap load signal and a reference load value that is indicative of a maximum allowable variation of the average blade flap load signal from a normal value.

According to another aspect of the invention there is provided a wind turbine comprising a control system as described in a previous aspect of the invention.

Within the scope of this invention it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible.

### BRIEF DESCRIPTION OF THE DRAWINGS

Examples of the invention will now be described with reference to the accompanying drawings, in which:

FIG. 1 schematically illustrates a wind turbine in accordance with an aspect of the invention;

FIG. 2 shows the steps of an exemplary method of determining a maximum thrust level for the wind turbine of FIG. 1 in accordance with an aspect of the invention;

FIG. 3A shows a plot of wind speed during an example period;

FIG. 3B shows exemplary plots of respective blade flap loads determined for each rotor blade of the wind turbine of FIG. 1 during the example period of FIG. 3A;

FIG. 3C shows an exemplary plot of an average blade flap load, during the example period of FIGS. 3A and 3B, determined in accordance with the method of FIG. 2; and

FIG. 4 schematically illustrates a control module arrangement for determining a maximum thrust level for the wind turbine of FIG. 1, the arrangement being implemented by one or more controllers of the wind turbine and using the method of FIG. 2.

### DETAILED DESCRIPTION

Examples of the invention advantageously provide for determining a maximum thrust level for a thrust limit controller to control a wind turbine in response to relatively fast changes in blade load, e.g. as a result of gusts.

Examples of the invention make use of the fact that the effects of relatively fast changes in wind speed are exhibited initially by the rotor blades of a wind turbine. Examples of the invention therefore use measurements of loading experienced by the rotor blades in order to capture shorter timescale changes in the rotor thrust, as described in more detail below.

However, the inventors have found that the blade load measurements for individual rotor blades exhibit cyclic variations that impair the ability to detect blade load variations due to short timescale changes in wind speed, e.g. as a result of gusts.

To mitigate this problem, examples of the invention advantageously combine blade load measurements determined for multiple rotor blades of the wind turbine by determining an average blade load based thereon. For example, a blade flap load signal may be received from a respective blade load sensor attached to each rotor blade of the wind turbine and an average blade flap load signal may be determined based on the received signals. In this manner, the cyclic variation of the flap load at each individual blade is substantially neutralized. Consequently, the average blade flap load signal can be used to detect when the average blade flap load varies outside of an acceptable range for normal operation of the wind turbine, i.e. to detect when the average blade flap load varies from an expected value for the prevailing conditions (e.g. average wind speed) due to gusts. In this context, the expected value for normal operation and/or the acceptable range of variation correspond to the current or (most) recent conditions and may therefore be updated continuously based on sliding windows. In this manner, the bounds of acceptable blade loads can be controlled more tightly in lower turbulence conditions.

The maximum thrust level can then be adjusted accordingly to protect the wind turbine. For example, the maximum thrust level can be dynamically adjusted to reduce the maximum thrust level in accordance with an increasing variation of the average blade load signal, for example producing a proportionate response to the magnitude of the wind speed increase.

It is envisaged that the invention will therefore provide for enhanced performance and responsiveness of wind turbines to relatively fast changes in wind speed, protecting the wind turbine from significant thrust load changes and thereby extending the lifetime of the wind turbine. The invention will simultaneously minimise periods of reduced power production and facilitate further optimisation of the wind turbine design, as the resulting reduced power production from a low maximum thrust level may be limited to periods where a high variation of the average blade flap load signal is present, whereas for periods of a low variation of the average blade flap load signal a higher maximum thrust level may be set.

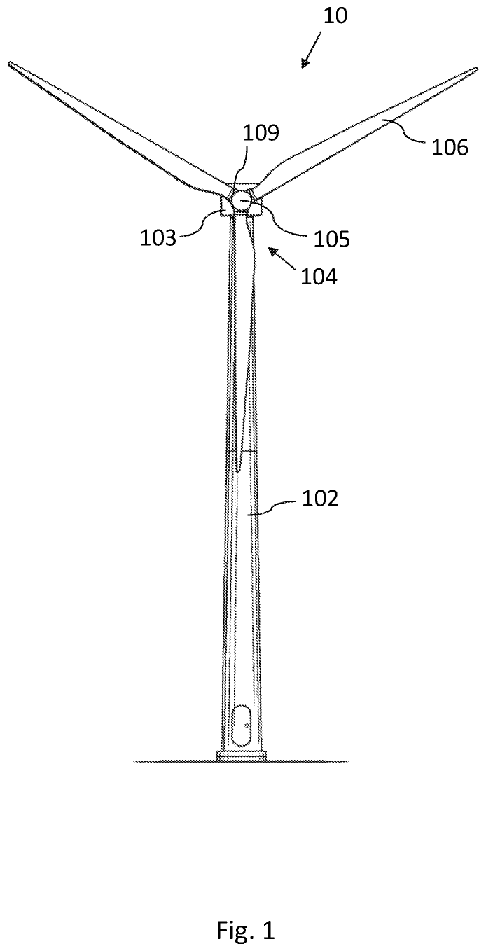

FIG. 1 illustrates, in a schematic view, an example of a wind turbine 10. The wind turbine 10 includes a tower 102, a nacelle 103 disposed at the apex of, or atop, the tower 102, and a rotor 104 operatively coupled to a generator housed inside the nacelle 103. In addition to the generator, the nacelle 103 houses other components required for converting wind energy into electrical energy and various components needed to operate, control, and optimise the performance of the wind turbine 10. The rotor 104 of the wind turbine 10 includes a central hub 105 and three rotor blades 106 that project outwardly from the central hub 105. The rotor blades 106 are pitch-adjustable. The rotor blades 106 can be adjusted in accordance with a collective pitch setting, where each of the blades are set to the same pitch value. The rotor blades 106 may additionally or alternatively be adjustable in accordance with individual pitch settings, where each blade 106 may be provided with an individual pitch setpoint. In other examples, it shall be appreciated that the rotor may include fewer or additional rotor blades projecting outwardly from the central hub.

In this example, the wind turbine 10 includes blade load sensors placed at, or in the vicinity of, each blade root 109 in a manner such that each sensor detects loading in the respective rotor blade 106. Blade load signals from such sensors may be used to determine how to adjust the pitch of each of the individual blades 106. Depending on the placement and the type of sensor, loading may be detected in the flap (flapwise) direction (in/out of plane) or in the edge (edgewise) direction (in-plane). Such sensors may be strain gauge sensors or optical Bragg-sensors, for instance.

A method for controlling the wind turbine 10 in accordance with examples of the invention is now described.

The method may be implemented by one or more controllers or other processing modules associated with the wind turbine 10. In particular, one or more wind turbine controllers for detecting relatively fast changes in the blade loads and determining respective control actions in response. The one or more wind turbine controllers may include or connect to a thrust limiter controller that receives a maximum thrust level for the wind turbine 10 and controls rotor blade pitch angle to ensure that loading experienced by the wind turbine rotor 104 is kept below the maximum thrust level (thereby reducing extreme loads and fatigue effects at one or more wind turbine components). As wind gusts can cause relatively fast increases in thrust loading, determining the maximum thrust level based on blade loads that include high frequency content, i.e. include load changes over a short timescale (e.g. less than a few seconds, such as less than two seconds), with minimal delay, ensures better or optimal performance of such a thrust limiter controller.

In examples, the controller(s) or processing module(s) may be located in the wind turbine 10, e.g. inside the nacelle 103, in the tower 102 or distributed at a number of locations inside the turbine 10 and communicatively connected to one another. Alternatively, the controller(s) (or parts thereof) may be located externally to the wind turbine 10.

The controller(s) may be in the form of any suitable computing device, for instance one or more functional units or modules implemented on one or more computer processors. Such functional units may be provided by suitable software running on any suitable computing substrate using conventional or customer processors and memory. The one or more functional units may use a common computing substrate (for example, they may run on the same server) or separate substrates, or one or both may themselves be distributed between multiple computing devices. A computer memory may store instructions for performing the methods performed by the controller, and the processor(s) may execute the stored instructions to perform the method.

The described method determines a maximum thrust level for the wind turbine rotor 104 using measured flap loads experienced by the rotor blades 106. The maximum thrust level is a limit value for the total (aerodynamic) force acting on the rotor 104 in a direction acting along the axis of rotation of the rotor 104, which is used to control the wind turbine 10. The measured flap loads, i.e. the loading in the flap direction of the blades, are obtained from the blade load sensors and each blade flap load measurement is indicative of the bending moment at the root 109 of the rotor blade 106. The maximum thrust level is then determined by combining, e.g. averaging, the measured flap load signals obtained for each rotor blade 106 and adjusting the maximum thrust level in dependence on the variations of the combined signal. In this manner, the thrust limit controller can control the wind turbine 10 to mitigate excessive thrust forces without needing to explicitly determine or estimate the actual thrust force experienced by the wind turbine 10.

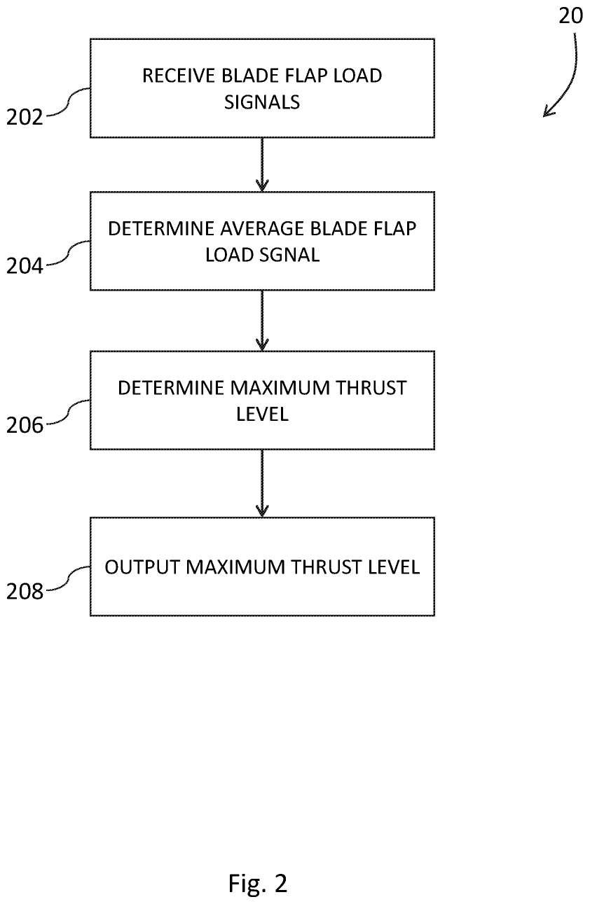

FIG. 2 schematically illustrates steps of a method 20 for controlling the wind turbine 10 in accordance with examples of the invention.

At step 202 of the method 20, a plurality of blade flap load signals is received at the wind turbine controller(s). Each blade flap load signal is indicative of measured flap loading on a respective one of the rotor blades 106 and may be obtained from the respective blade load sensor. In examples, the blade flap load signals may be received for some or each of the rotor blades 106.

In examples, each of the plurality of blade flap load signals may be passed through a high-pass filter to attenuate load variations below a cut-off frequency, thereby limiting the subsequent analysis to the higher frequency components and producing a mean blade flap load of substantially zero. In other words, in order that each blade flap load signal may only include load deviations as a result of high frequency content, the processing module may apply filtering to attenuate low frequency content from each of the blade flap load signals, thereby producing a mean blade flap load of approximately zero for each signal.

At step 204, the blade flap load signals are combined in a suitable manner to obtain a representative blade flap load signal for the rotor blades 106. For example, the plurality of blade flap load signals, which may have been passed through a high-pass filter, may be summed together and divided by the number of blade load signals to determine an average blade flap load signal.

To give an example, a blade flap load signal may be received for each of the three rotor blades 106 of the wind turbine 10 shown in FIG. 1 and the signals may therefore be approximately 120 degrees out of phase. By summing the three blade flap load signals together, and determining an average blade flap load signal, the cyclic load variations at each individual blade are mitigated by the phase difference of the other signals. The high frequency content can therefore be retained without the cyclic variations giving rise to false indications of short-timescale load variations due to gusting, for example.

In examples, the wind turbine control may be further improved by additionally filtering the higher frequency cyclic load variations that remain in the average blade flap load signal as successive rotor blades 106 pass the tower 102 during each rotation. For this purpose, a notch filter may be applied to the determined average blade flap load signal. The notch filter may be configured to attenuate the 3P frequency (i.e. three time the rotor frequency), for example. In examples, the notch filter may be further configured to additionally or alternatively attenuate the 6P, and/or the 9P frequencies (i.e. six or nine times the rotor frequency).

At step 206, the method 20 involves determining a maximum thrust level for the wind turbine 10 based on the average blade flap load signal.

For this purpose, the average blade flap load signal is analysed to determine unacceptable variations, for example due to sudden changes in wind speed or direction, that require a reduction of the maximum thrust level to protect the wind turbine 10. The variations of the average blade flap load signal are therefore analysed relative to a standard or normal blade flap load for the prevailing conditions, such as current/recent wind speed and direction, as discussed in more detail below.

Accordingly, in order to determine whether a reduction of the maximum thrust level is required, the average blade flap load signal may be compared to a reference load value that is indicative of a maximum allowable variation of the average blade flap load signal from a normal value of the average blade flap load signal. The normal value of the average blade flap load signal may be a mean, median, or mode value of the average blade flap load, for example.

For example, the normal value of the average blade flap load signal and/or the reference load value may be determined or updated at a prescribed frequency based on successive intervals of the average blade flap load signal. In this manner, the mean value and/or the reference load value may be updated to account for the current and/or recent wind conditions. The reference load value can therefore be updated at regular intervals to adapt to longer term wind speed changes, and/or to adapt to relatively stable or turbulent conditions for example, during which wind speed variations may be relatively small or relatively large respectively.

To give an example, the normal value of the average blade flap load signal and/or the reference load value may therefore be determined or updated at each timestep using a sliding window that samples successive intervals of less than or equal to 1 minute. In this manner, the values may be considered to correspond the current wind conditions. However, this example is not intended to be limiting on the scope of the invention and, in other examples, the intervals may be period of less than or equal to 30 seconds, or up to 10 minutes, or even an hour for example.

In examples, a standard deviation of the average blade flap load signal may be determined as measure of acceptable variation for use in determining the reference load value. The use of a standard deviation allows the time taken to detect sudden load increases to be minimised, particularly in low turbulence conditions where the maximum thrust level may be set at a relatively high level. Minimizing the reaction in such conditions is vital for mitigating the thrust loads experienced by the rotor 104. However, it shall be appreciated that other measures of acceptable variation from a normal value may also be suitable.

As the plurality of blade flap load signals are each high pass filtered in this example, having a zero mean load value, the normal value of the average blade flap load signal is therefore a zero-load value in this example.

An unacceptable variation may therefore be considered to be an average blade flap load signal, that is greater than a reference load value equal to X1 times the standard deviation from the mean value, where X1 is a prescribed scalar coefficient. For example, X1 may be a positive integer.

If the average blade flap load signal remains less than or equal to the reference load value of X1 times the standard deviation, the maximum thrust level may be set at a first thrust level, T1.

However, if the average blade flap load signal is greater than the reference load value, the maximum thrust level may be reduced to protect the wind turbine 10.

For this purpose, the controller(s) may include one or more rules, algorithms, or functions for reducing the maximum thrust level in dependence on values of the average blade flap load signal that are greater than the reference load value. Such rules, algorithms, or functions may allow for rapid adjustments of the wind turbine 10 when the average blade flap load signal exceeds the reference load value. For example, the controller(s) may be configured to determine the maximum thrust level based on a function for transitioning from the first thrust level, T1, to a reduced second thrust level, T2, for average blade flap load values between first and second reference load values, such as X1 and X2 times the standard deviation from the mean. In this respect, X2 may be a prescribed scalar coefficient that is greater than or equal to X1 and may be a positive integer, for example. To give an example, X1 may be equal to 4 and X 2 may be equal to 6.

Accordingly, as the average blade flap load signal increases from X1 times the standard deviation to X2 times the standard deviation, the maximum thrust level reduces according to the transition function. For example, the transition function may proportionally scale the maximum thrust level from the first thrust level, T1, down to the second thrust level, T2, as the average blade flap load signal increases from X1 to X2 times the standard deviation. Thereafter, for average load blade flap loads that are greater than or equal to the second reference load value (X2 times the standard deviation), the maximum thrust level may be held at the second thrust level, T2, for example. The second thrust level, T2, may therefore define a minimum value of the maximum thrust level, which protects the wind turbine from short-timescale changes in wind speed/direction without incurring unnecessary or excessive periods of reduced power production of the wind turbine 10.

In this manner, the average blade flap load signal is used to determine short timescale load deviations, that may arise due to gusts for example, by comparison to a reference load deviation that is considered normal or acceptable for the prevailing wind conditions.

The maximum thrust level can therefore be adjusted accordingly to protect the wind turbine 10 from damage.

In step 208, the determined maximum thrust level is output to control the wind turbine 10. For example, the maximum thrust level may be output to one or more wind turbine controllers for ensuring that the loading experienced by the wind turbine rotor 104 is kept below the maximum thrust level. For example, the maximum thrust level may be output to a thrust limiter controller that controls rotor blade pitch angle to ensure that the loading experienced by the wind turbine rotor 104 is kept below the maximum thrust level.

For instance, the thrust limit controller may transmit a collective pitch reference or operating point (to a pitch actuator system of the wind turbine 10) in accordance with which the pitch angle of the rotor blades 106 is to be controlled.

In an embodiment, the thrust limiter may set a minimum pitch angle which ensures that the rotor thrust is below the maximum thrust level. The thrust limiter controller may compare the desired pitch angle to the minimum pitch angle and output the desired pitch angle if the desired pitch angle is larger than the minimum pitch angle and output the minimum pitch angle if the desired pitch angle is smaller than the minimum pitch angle.

In this manner, sudden blade load changes, for example due to gusts, can be distinguished from noise and typical cyclic variations, allowing for the maximum thrust level to be rapidly adapted to protect the wind turbine 10 from excessive transient loads, without unnecessarily reducing power production.

It is envisaged that the invention will therefore provide for enhanced responsiveness of wind turbines to relatively fast changes in wind speed, protecting the wind turbine from significant thrust load changes and thereby extending the lifetime of the wind turbine, without unnecessarily curtailment.

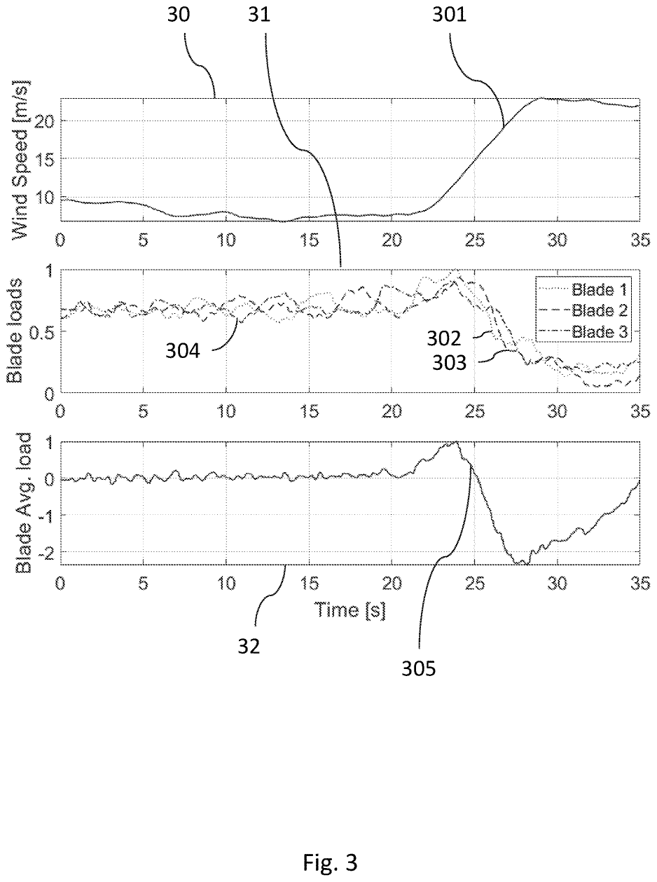

FIG. 3A shows a plot 30 of a wind speed curve 301 describing wind speed measurements at the wind turbine 10 during an example period. In the illustrated example, a short-lived wind speed increase is evident after approximately 22 seconds of the period have elapsed. For comparison, FIG. 3B shows a plot 31 of first, second and third blade flap load curves 302, 303, 304 received from the respective blade load sensors during the example period and FIG. 3C shows a plot 32 of an average blade flap load signal curve 305, determined in accordance with step 204 of the method 20, based on the first, second and third blade flap load curves 302, 303, 304.

As is evident in FIGS. 3B and 3C, the load fluctuations of the individual blade load sensors are mitigated in the determined average blade flap load curve 305, such that the normal value of the average blade flap load curve 305 is zero and the deviation caused by the short timescale increase in wind speed (after 22 seconds) is distinguishable from the relatively high frequency deviations of the remaining effects. Consequently, in accordance with step 206 of the method 20, respective load thresholds can be set to reflect acceptable and unacceptable load deviations and the short-lived deviations can be effectively mitigated, thereby maintaining a maximum thrust level without unnecessarily pitching the blades and/or reducing power production.

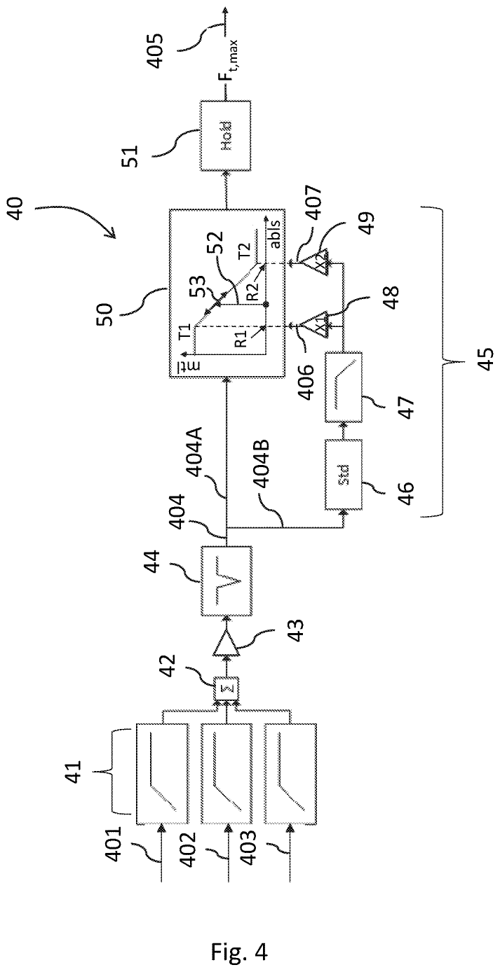

FIG. 4 schematically illustrates a processing or control module arrangement 40 that may be implemented by the wind turbine controller(s) in accordance with examples of the invention. In particular, a first blade flap load signal 401 is obtained from a first blade load sensor, a second blade flap load signal 402 is obtained from a second blade load sensor and a third blade flap load signal 403 is obtained from a third blade load sensor. In the illustrated embodiment, each of the first, second and third blade flap load signals 401, 402, 403 are filtered by application of respective high-pass filters 41 to attenuate low frequency content, thereby producing a mean load of zero for each blade flap load signal 401, 402, 403. In other words, in order that the blade flap load signal 401, 402, 403 only include load deviations due to high frequency content, the processing module may apply filtering to remove low frequency content from each of the blade flap load signals 401, 402, 403.

High frequency content may be defined in any suitable manner. As a purely illustrative example though, high frequency content may be content greater than 0.5 Hz. Similarly, low frequency content may be defined in any suitable manner. As a purely illustrative example, low frequency content may be content less than 0.1 Hz.

In some examples, the high pass filtering applied to each blade flap load signal 401, 402, 403 may be tuned to pass through content near a first flapwise eigen-frequency of the respective rotor blade 106, which will vary depending on the specific size of the rotor 104 and the rotor blade length.

The high pass filtered signals are then summed together at a summing junction 42 and the summed signal is divided by the number of blade flap load signals 401, 402, 403 received (three in this example) at a dividing junction 43 to a determine an average blade load signal 404. In the illustrated example, a notch filter 44 is applied to the average blade load signal 404 to attenuate the cyclic effects that arise, for example, as successive rotor blades 106 pass the tower 102 during each rotation, also referred to as the 3P frequency.

The determined average blade load signal 404 is subsequently used to determine the maximum thrust level 405. In particular, the average blade load signal 404 is passed to a processing module 45 for determining the maximum thrust level 405 based on the average blade load signal 404. The average blade load signal is split in two signal paths 404A and 404B. A first signal path 404A is used as one of the inputs into the thrust conversion module 50, the average blade load signal being abbreviated as ‘abls’ and shown as values along the x-axis of the shown graph mapping the maximum thrust level, here abbreviated as ‘mtl’, as a function of the average blade load signal.

The processing module 45 analyses the average blade load signal 404 to determine whether there are sudden short-lived increases in the blade load that require a reduction of the maximum thrust level. For this purpose, the processing module 45 determines reference load values based on the second signal path 404B as further inputs into the thrust conversion module 50 that define thrust limits of acceptable load variation for normal operation in the current conditions, and determines the maximum thrust level by comparing the average blade load signal abls, 404, 404A to such reference load values R1, R2, 406, 407.

As shown in FIG. 4, the processing module 45 may therefore include a standard deviation module 46, a low pass filter 47, first and second gain modules 48, 49 and a thrust conversion module 50 for this purpose.

In particular, the average blade load signal 404B is first passed to the standard deviation module 46 which determines the standard deviation of the average blade load signal 404, 404B to measure typical variation of the average blade load signal 404 in the current conditions. The standard deviation may be determined at regular intervals or at each timestep, for example, to adapt to the current wind conditions, and particularly the relative turbulence thereof.

The processing module 45 determines the standard deviation of the average blade flap load signal, as a measure of acceptable variation, such that the control module arrangement 40 can minimize the detection time in low turbulence conditions. In particular, in low turbulence conditions, the control module arrangement 45 is relatively sensitive to load variations compared to relatively turbulent conditions, which is appropriate because the maximum thrust level is typically set to a high static thrust in low turbulence conditions, due to other parts of the thrust limiter, which makes the wind turbine 10 vulnerable to sudden wind speed increases. In contrast, in extreme turbulence conditions, the maximum thrust level is typically set to a low level by the other parts of the thrust limiter, such that the tolerance is reasonably higher.

The low-pass filter 47 removes high frequency content from the output of the standard deviation module 46 and the filtered output is passed to the first and second gain modules 48, 49. The first gain module 48 produces a first input signal 406 to the thrust conversion module 50 and the second gain module 48 produces a second input signal 407 to the thrust conversion module 50, for use in defining respective reference loads for comparison to the average blade flap load signal abls, 404, 404A.

In particular, the first input signal 406 is equal to X1 times the low pass filtered standard deviation of the average blade load signal and forms the first reference load value R1. Similarly, the second input signal 407 is equal to X2 times the low pass filtered standard deviation of the average blade load signal and forms the second reference load value R2. Here, X1 is the first gain determined by the first gain module 48 and X2 is the second gain determined by the second gain module 49, and X2 is greater than or equal to X1 to provide a larger reference load value.

In the above example it shall be appreciated that the normal value is a zero-load value due to the high-pass filters 41, such that there is no need to explicitly determine the normal value as the mean value. However, in other examples, the normal value of the average blade load signal may instead be determined for successive intervals (e.g. as the mean, mode or median value) using a sliding window. Moreover, in an alternative implementation, the first and second reference load values may be determined by adding the first and second input signals 406, 407 respectively to the determined normal value.

The thrust conversion module 50 receives the first and second input signals 406, 407 and the average blade flap load signal abls, 404, 404A and determines a corresponding maximum thrust level. Considered in more detail, the thrust conversion module 50 uses the first input signal 406 to determine the lower load reference value (equal to X1 times the standard deviation in this case) and the second input signal 407 to determine an upper load reference value (equal to X2 times the standard deviation in this case). The thrust conversion module 50 therefore determines the first thrust level, T1, for average blade flap loads that are less than or equal to the lower reference load value. The thrust conversion module 50 applies a function for linearly reducing the maximum thrust level from the first thrust level, T1, to the second thrust level, T2, for average blade flap load values between the lower refence load value and the upper reference load value. If the average blade flap load value is greater than or equal to the upper reference load value, the thrust conversion module 50 sets the maximum thrust level to the second thrust level, T2 to protect the wind turbine 10 accordingly.

The first thrust level, T1, may be larger than or equal to a maximum expected thrust level for the wind turbine 10, for example. In examples, the first and second thrust levels, T1, T2 may be determined in dependence on the current operation of the wind turbine 10 and may be set by other parts of the wind turbine control, for example with reference to one or more look-up tables.

The thrust levels T1 and T2 may be preset levels set in a tuning process. These thrust levels may be the thrust force that can maximally be allowed (the maximum allowable thrust force) in view of the variation level of the average blade flap load signal. The thrust level T1 may be set in a tuning process to an appropriate maximal thrust level for stable wind conditions, i.e. wind conditions giving rise to a low variation level in the average blade load, whereas the thrust level T2 may be set in a tuning process to an appropriate maximal thrust level for changing wind conditions, i.e. wind conditions giving rise to a high variation level in the average blade load. The reference levels R1 and R2 can be set in a tuning process to set how fast the transition from the high maximal thrust level to the low maximal thrust level should be. In this manner the maximal thrust level of a wind turbine may be tailored to the specific wind turbine design variants and specific wind turbine site conditions in a flexible manner.

The determined maximum thrust level is held by a hold module 51, that applies a hold function for stability purposes, before the maximum thrust level signal 405 is output to one or more wind turbine controllers that determine corresponding control actions. The hold module 51 may provide greater stability in certain conditions. For example, the hold time may be a predetermined period in the order of approximately 10 seconds, such as between 2 and 20 seconds and ensures that the wind turbine 10 is not controlled to pitch in immediately after pitching out. This could otherwise lead to an instability or limit cycle phenomenon switching the thrust limit on and off continuously. A short hold period results in a fast return to the high thrust level T1 when the fluctuation of the average blade load signals is reduced, and a long hold period results in that a low thrust level is maintained longer.

The hold function may be implemented as an asymmetric hold function. In an asymmetric hold function the determined maximum thrust level is only held if the average blade load signal decreases, i.e. the asymmetric hold function may be implemented to hold the determined maximum thrust level for a predefined period for a decreasing average blade flap load signal and to adjust the determined maximum thrust level for an increasing average blade flap load signal. This is illustrated in FIG. 4 by the arrows 52 and 53. In a situation where a given average blade load value is measured as shown by arrow 53, a corresponding maximum thrust level is determined. The following average blade load values may either be larger or smaller resulting in that the resulting maximum thrust level changes as illustrated by arrow 53. If the average blade load signal goes towards smaller values (higher maximum thrust level) the hold module holds the value, whereas if the average blade load signal goes towards higher values (lower maximum thrust level) this value is set as the maximum thrust level. If after expiry of the predetermined period, the values have remained lower than the initial value, the maximum thrust level is increased, typically by use of a preset ramp to avoid signal jumps. If during the predetermined period, higher values have been detected, the predetermined period is reset every time a higher value is detected.

The output signal 405 may be used as an input to a thrust limiter controller, for example, in which rotor blade pitch angle is controlled to ensure that loading experienced by the wind turbine rotor 104 is kept below a maximum thrust level (thereby reducing fatigue to one or more wind turbine components).

As the maximum thrust level signal 405 is intended to protect the wind turbine 10 against relatively fast changes in load, the maximum thrust level signal 405 may be updated relatively frequently or substantially continuously to ensure such changes are reflected in the determination of the maximum thrust level. For example, the blade flap loads may be sampled at a defined sampling rate of the controller 40. The method to obtain the maximum thrust level may be performed on each set of sampled data (blade loads), i.e. at each time step. Alternatively, the maximum thrust level signal 405 may be updated at defined time steps, i.e. at defined time intervals.

The invention therefore provides for enhanced wind turbine protection, and reduced tower loads, without unnecessarily reducing power production.

FIG. 4 illustrates a specific advantageous implementation of the invention comprising a number of embodied elements. While each described element represents an advantageous embodiment of that element, not all elements need to be implemented in the illustrated manner in order to achieve an advantageous working implementation of the invention.

Many modifications may be made to the described examples without departing from the scope of the appended claims.

1. A method of controlling a wind turbine comprising a rotor and a plurality of rotor blades, the method comprising:
receiving a plurality of blade flap load signals indicative of measured flap loading on respective rotor blades, each blade flap load signal being received from a blade flap load sensor of a respective rotor blade;
determining an average blade flap load signal based, at least in part, on the plurality of blade flap load signals; and
determining a maximum thrust level for a thrust limit controller based on the average blade flap load signal and a reference load value that is indicative of a maximum allowable variation of the average blade flap load signal from a normal value.

2. A method according to claim 1, further comprising determining the reference load value based on respective intervals of the average blade flap load signal, optionally, the reference load value is determined at a prescribed frequency.

3. A method according to claim 1, wherein the reference load value is based on a standard deviation of the average blade flap load signal.

4. A method according to claim 1, wherein the maximum thrust level is determined as:
a first thrust level if the average blade flap load signal is less than or equal to the reference load value; and
a second thrust level if the average blade flap load signal is greater than the reference load value, wherein the second thrust level is less than the first thrust level.

5. A method according to claim 4, wherein determining the maximum thrust level further comprises:
comparing the average blade flap load signal to a further reference load value that is indicative of a greater variation of the average blade flap load signal from the normal value; and
determining the maximum thrust level as the second thrust level if the average blade flap load signal is greater than the further reference load value.

6. A method according to claim 5, wherein the method further comprises determining the maximum thrust level based on a function for transitioning from the first thrust level to the second thrust level, if the average blade flap load signal is greater than the reference load value but less than or equal to the further reference load value.

7. A method according to claim 6, wherein the function includes a proportional reduction from the first thrust level toward the second thrust level according to a difference between the average blade flap load signal and the reference load value.

8. A method according to claim 1, wherein the further reference load value is also based on the standard deviation of the average blade flap load signal, the reference load value and the further reference load value being equal to respective multiples, X1 and X2, of the standard deviation of the average blade flap load signal from the mean of the average blade flap load signal, where X2 is greater than X1.

9. A method according to claim 8, wherein determining at least one of the reference load value and/or the further reference load value comprises applying a low-pass filter to the standard deviation of the average blade flap load signal.

10. A method according to claim 1, wherein each of the plurality of blade flap load signals are high pass filtered prior to determining the average blade flap load signal based thereon; and
wherein a notch filter is applied to the average blade flap load signal prior to determining the maximum thrust level based thereon.

11. A method according to claim 1, wherein a hold function is applied to the determined maximum thrust level.

12. A method according to claim 11, wherein the hold function is an asymmetric hold function implemented to hold the determined maximum thrust level for a predefined period for a decreasing average blade flap load signal and to adjust the determined maximum thrust level for an increasing average blade flap load signal.

13. A method according to claim 1, further comprising outputting the determined maximum thrust level to the thrust limit controller to control a pitch angle of the plurality of rotor blades based on the determined maximum thrust level.

14. A non-transient, computer-readable storage medium storing instructions thereon that when executed by one or more processors cause the one or more processors to execute a method according to claim 1.

15. A control system for a wind turbine comprising a rotor and a plurality of rotor blades, the control system comprising one or more controllers configured to:
receive a plurality of blade flap load signals indicative of measured flap loading on respective rotor blades, each blade flap load signal being received from a blade flap load sensor of a respective rotor blade;
determine an average blade flap load signal based, at least in part, on the plurality of blade flap load signals; and
determine a maximum thrust level for a thrust limit controller based on the average blade flap load signal and a reference load value that is indicative of a maximum allowable variation of the average blade flap load signal from a normal value.

16. A wind turbine comprising:
a tower;
a nacelle disposed on the tower;
a rotor extending from the nacelle and having a plurality of rotor blades disposed thereon; wherein each rotor blade has a respective blade flap load sensor;
a control system comprising:
receive a plurality of blade flap load signals indicative of measured flap loading on respective rotor blades, each blade flap load signal being received from the blade flap load sensor of a respective rotor blade;
determine an average blade flap load signal based, at least in part, on the plurality of blade flap load signals; and
determine a maximum thrust level for a thrust limit controller based on the average blade flap load signal and a reference load value that is indicative of a maximum allowable variation of the average blade flap load signal from a normal value.
